(19) United States
(12) Patent Application Publication
(10) Pub. No.: US 2012/0185322 A1
(43) Pub. Date: Jul. 19, 2012

(54) SYSTEM AND METHOD FOR PROVIDING A REBATE CARD FROM A KIOSK

(76) Inventor: Mark Shipley, Minnetonka, MN (US)

(21) Appl. No.: 13/006,219

(22) Filed: Jan. 13, 2011

(51) Int. Cl. G06Q 30/00

(52) U.S. Cl. 705/14.34

(57) ABSTRACT

Disclosed is a method for providing a rebate card to a consumer using an electronic kiosk, including receiving, into the kiosk, consumer information and rebate information; transmitting, from the kiosk, the consumer information and the rebate information, via an electronic network, to a rebate processor; and dispensing, from the kiosk, the rebate card to the consumer, wherein, upon receiving the consumer information and the rebate information, the rebate processor validates the information and directs a rebate card account manager to add a value to the rebate card. Disclosed is a system for providing a rebate card to a consumer, including: an electronic kiosk, the kiosk including: an electronic data input means; an electronic data transmission means; and a rebate card dispensing means; and a rebate card configured to be stored within and dispensed from the kiosk, wherein the kiosk is configured to receive rebate information and consumer information from a consumer through the data input means, transmit the rebate and consumer information to a rebate processor via the data transmission means, and dispense a rebate card to the consumer via the rebate processing means. Variations of the method and system are also disclosed.

### FIELD OF THE DISCLOSURE

The present disclosure relates to the redemption of product marketing rebates. Particularly, the present disclosure relates to rebate cards, such as stored value rebate cards or pre-paid rebate cards. More particularly, the present disclosure relates to systems and methods for providing stored value rebate cards to consumers from an ATM or kiosk.

### BACKGROUND OF THE DISCLOSURE

Commercial businesses are constantly looking for new ways to retain and/or increase client base. Product marketing rebates are well-known to most consumers and have been used by manufacturers as a tool for promoting and selling products by providing consumers with an incentive to purchase particular products, sometimes during a specific period. Typically, in a rebate system, a consumer will purchase a product and subsequently submit a rebate claim for that product along with identifying information, such as the consumer's name, address, telephone number, e-mail address, etc. This criteria typically includes filling out a specific rebate form with the name and address of the consumer, enclosing a cash register receipt showing where and when the item was purchased, and sometimes enclosing the Universal Product Code (UPC) or other designated portion of the product packaging to show that the product was actually consumed. On receipt of the rebate claim and consumer identifying information, the manufacturer, or an agent of the manufacturer, such as a rebate processing center, will transfer the value of the rebate to the consumer. Thus, the consumer is provided with an incentive to purchase products having rebate offers.

Recently, commercial businesses have offered rebates in the form of instant rebate cards and/or loyalty cards. With regard to instant rebate cards, consumers receive a card upon purchase of a qualifying product that entitles the consumer to an immediate discount on the purchase price of such product, thereby lowering the purchase price of such product in the amount of the rebate. In some cases, the instant rebate card may be reusable, and may entitle the consumer to additional rebates, discounts, and the like at future visits to the business. With regard to conventional loyalty cards, consumers may submit a rebate claim in a method known in the art. However, rather than receiving a conventional check, the consumers may receive a credit to their loyalty card for a value for the amount of the rebate that the consumer may then use at the commercial business that offered the rebate and for which the loyalty card is associated. As with the instant rebate card, the loyalty card may be reusable, and may entitle the consumer to additional rebates, discounts, and the like at future visits to the business.

A drawback of the prior art instant rebate and loyalty card systems is that a consumer must use the rebate card at a commercial business that is specified for them. Also, if several retailers were to issue instant rebate or loyalty cards, the consumer's wallet or pocketbook would soon be bulging with cards for every retailer they patronize, e.g., drug store, grocery store, electronics store, office supply store, toy store, department store, restaurant, etc. Thus, in many instances, the consumer is worse off with an instant rebate card or a loyalty card than with a simple rebate check. Additionally, there is some financial burden on the retailer that is inherent in the administration of an instant rebate card system or a loyalty card system. Similarly, the commercial business that initially offers a rebate will not likely want to financially support a rebate program wherein the consumer can use the rebate at any location the consumer desires, such as any location that accepts payment by credit.

A stored value account has a stored monetary value, and access to the stored value account is granted through use of a stored value instrument, such as a stored value card. The account value may be augmented, set, and/or changed by an account manager. The stored value account typically has a “closed” or an “open” format. A closed-format account is restricted to use for purchases from specific vendors. For example, a stored value card provider, such as a rebate card account manager or merchant, may issue a stored value card branded with respect to the merchant that is linked to a stored value account that will only distribute funds when the stored value card is used at a location of the merchant, or in some cases its website. The stored value card may also be authorized for use at subsidiaries or partners of the merchant. In contrast, an open-format account is not limited to specific merchants. Open-format prepaid instruments are typically issued by or associated with a credit card processor such as American Express™ or Visa™, etc.

Stored value accounts offer consumers financial flexibility in a variety of ways. Consumers may carry a stored value card in lieu of cash, eliminating the hassles of paper money such as damaged or dirty bills, unwieldy wads of bills, piles of change, and currency exchange when traveling. Consumers may also prefer the prepaid instrument to a credit or debit card because the prepaid account contains a limited stored value, capping the financial loss if the prepaid instrument is lost or stolen.

Lacking in the art are systems and methods that provides the consumer with a rebate that engages the user in the rebate process, while still maintaining a high level of security and fraud prevention through a validation process. Further lacking in the art are systems and methods that allow the rebate provider to monitor the consumer's purchases using the rebate to better develop an ongoing business relationship with the consumer.

### BRIEF SUMMARY OF THE DISCLOSURE

Accordingly, in one embodiment, disclosed herein is a method for providing a rebate card to a consumer using an electronic kiosk, which may include receiving, into the kiosk, consumer information and rebate information; transmitting, from the kiosk, the consumer information and the rebate information, via an electronic network, to a rebate processor; and dispensing, from the kiosk, the rebate card to the consumer, wherein, upon receiving the consumer information and the rebate information, the rebate processor may validate the information and direct a rebate card account manager to add a value to the rebate card.

In another embodiment, disclosed herein is a system for providing a rebate card to a consumer, which may include: an electronic kiosk, the kiosk including: an electronic data input means; an electronic data transmission means; and a rebate card dispensing means; and a rebate card configured to be stored within and dispensed from the kiosk, wherein the kiosk may be configured to receive rebate information and consumer information from a consumer through the data input means, transmit the rebate and consumer information to a rebate processor via the data transmission means, and dispense a stored value rebate card to the consumer via the rebate processing means.

In a further embodiment, disclosed herein is a method for processing a rebate claim using a computer-implemented processing system, which may include: receiving, into the processing system, rebate information and consumer information, via an electronic network, from a kiosk configured to provide a rebate card to the consumer; validating in the processing system, using electronically implemented validating procedures, the rebate information and the consumer information; electronically notifying a rebate account manager to add a value to the rebate card; and electronically notifying the consumer that the rebate card has a value added.

While multiple embodiments are disclosed, including variations thereof; still other embodiments of the present disclosure will become apparent to those skilled in the art from the following detailed description, which shows and describes illustrative embodiments of the disclosure. As will be realized, the disclosure is capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE FIGURES

While the specification concludes with claims particularly pointing out and distinctly claiming the subject matter that is regarded as forming the present disclosure, it is believed that the disclosure will be better understood from the following description taken in conjunction with the accompanying Figures, in which:

FIG. 1 is an example block diagram representation of the interrelationship of the participants in a rebate system and method in accordance with one embodiment of the present disclosure.

FIG. 2 is a flowchart of a rebate method in accordance with one embodiment of the present disclosure.

FIG. 3a is a diagram of an example kiosk or ATM suitable for use with the systems and methods of the present disclosure.

FIG. 3b is an example screenshot of the kiosk or ATM of FIG. 3a.

FIG. 3c is an example rebate card suitable for use with the kiosk or ATM of FIG. 3a.

FIG. 3d is an example computer-implemented system suitable for use with the kiosk or ATM of FIG. 3a.

FIG. 4 is an example block diagram representation of a rebate system and method in accordance with one embodiment of the present disclosure.

### DETAILED DESCRIPTION

### Overview

The present disclosure relates to a novel and advantageous system and method for providing stored value rebate cards to consumers. Stored value rebate cards may include any debit or credit card, including Visa™, Mastercard™, Discover™, American Express™, or other credit card, loyalty card, smartcard, scannable device, or other card or device suitable for storing information relating to a stored value rebate card or rebate offer.

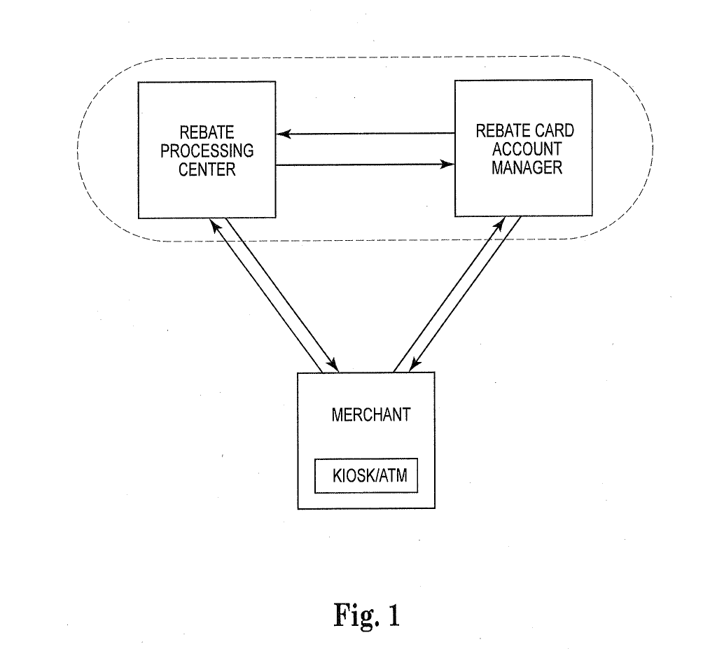

FIG. 1 presents a broad, high-level overview, in one embodiment, of the interrelationship between certain participants in the presently disclosed system, including a merchant, a rebate processing center, and a rebate card account manager. Of course, more or fewer participants may be included in other embodiments. First, with regard to the merchant, as shown in FIG. 1, the merchant may have an electronic kiosk or ATM associated therewith. The merchant may sell products that qualify a purchasing consumer to receive a rebate on such products. Upon purchase of a qualifying product, the merchant may provide the consumer with rebate information, which may be in the form of one or more rebate documents. The consumer may then use the ATM or kiosk associated with the merchant to submit a rebate claim, using the rebate information. Upon submission of a rebate claim, the kiosk or ATM may provide the consumer with a rebate card, which in some embodiments may have a stored value thereon, and in other embodiments may be configured to receive a stored value at a later date.

As further shown in FIG. 1, a rebate processing center may have a relationship, which may be a business relationship, with the merchant. The merchant may send information to the rebate processing center regarding the purchase of rebate qualifying products by one or more consumers. Further, the kiosk or ATM associated with the merchant may transmit rebate claim information (as entered by the consumer) to the rebate processing center. Upon receipt of such information, the rebate processing center may process and/or validate the rebate claim based on the information received from the consumer (through the kiosk or ATM) and from the merchant. The rebate processing center may, in turn, provide rebate notification and/or validation information back to the merchant, the kiosk or ATM, and/or the consumer upon processing or validation of the rebate.

Further still as shown in FIG. 1, a rebate card account manager may have a relationship, which may be a business relationship, with both the merchant and the rebate processing center. In one particular embodiment, the rebate card account manager may be, or may be directly associated with, the rebate processing center, as indicated by the dotted line. The rebate card account manager may generally be responsible for the operation and administration of systems that allow a stored value to be associated with the rebate card received by the consumer, and further for the operation and administration of systems that allow the consumer to use such rebate card for the purchase of products from the merchant (or from other merchants). The rebate card account manager may receive rebate validation information from the rebate card processing center, and, using such information, may associate a value with the rebate card received by the consumer. The rebate card account manager may, in turn, send rebate card value information back to the merchant, the rebate card processing center, and/or the consumer once the rebate card account manager has associated a value with the consumer's rebate card. The rebate card account manager may also send rebate card use information to the merchant and/or the rebate card processing center, when the consumer uses the rebate card to make subsequent purchases. Such rebate card use information may include the location where the card was used, the items purchased, and/or other information the may be used by the merchant and/or the rebate card processing center to build a continuing business relationship with the consumer.

With general reference now to a method of providing a rebate card in accordance with the present disclosure, in one embodiment, a rebate offer may be provided to a consumer in relation to the purchase of a particular product or combination of products from a merchant or manufacturer offering the rebate. A consumer may then submit a claim to a rebate processing center for redemption of the rebate. The consumer may submit a rebate claim by entering information, which may include rebate information regarding the purchase of the eligible product as well as personal information regarding the consumer, into a kiosk or ATM (automated teller machine) located within the merchant store, within a larger shopping venue (e.g., mall, strip mall, outlet mall, or other shopping center), or at another location. The kiosk or ATM may be communicatively connected to a rebate processing center, whereby the rebate processing center receives information entered by the consumer via remote electronic connection. The consumer may receive a stored value card that, in one embodiment, may be initially “empty” (e.g., having zero value stored thereon) after entering the information.

The rebate processing center may, among other rebate processing, validate the request for redemption from the consumer and notify a rebate card account manager of the request. In the case of a debit or credit card, the rebate card account manager may be a financial institution. In the case of a loyalty card or smartcard, the rebate card account manager may be a rebate card issuer, such as a merchant. In some embodiments, the rebate card account manager may also be the processing center. The rebate processing center may select from a variety of rebate processing and validation systems and methods. The rebate card account manager may subsequently add value to the consumer's rebate card, upon validation of the rebate.

The rebate processing center or rebate card account manager may thereafter notify the consumer that a value has been added to the consumer's card. The consumer may then use the stored value rebate card at any location, where the rebate card is accepted, which may generally be any location, or it may be limited to certain locations, such as the merchant location where the rebate was received. The rebate card account manager may further fulfill payment obligations upon consumer use of the stored value rebate card.

### Method of Providing a Rebate Card to a Consumer

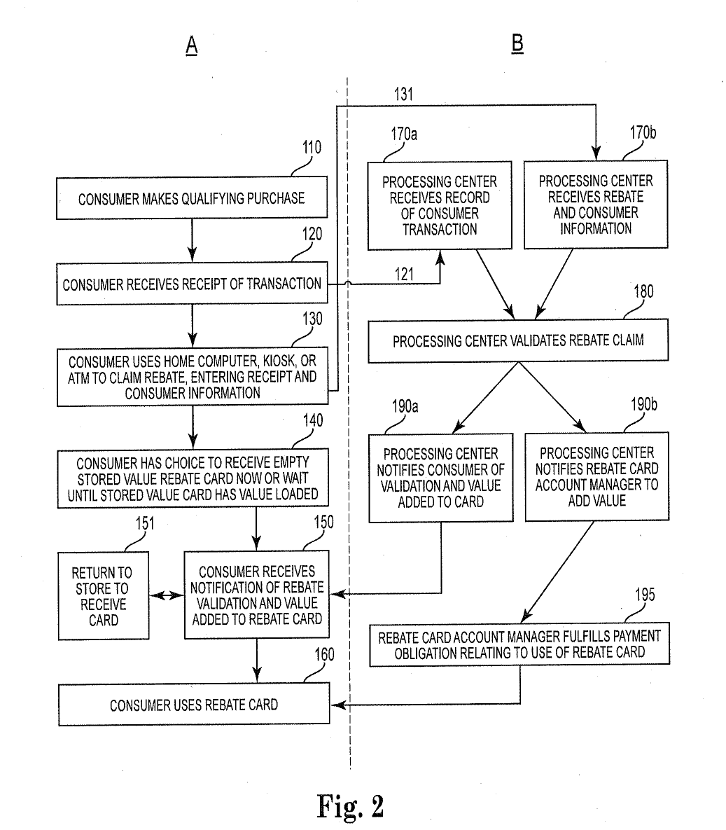

FIG. 2 illustrates generally a stored value rebate card system and method 100 in accordance with one embodiment of the present disclosure. For ease of discussion, side “A” of FIG. 2, including blocks 110 through 160, illustrates interactions between the systems and methods disclosed herein and the consumer, whereas side “B” of FIG. 2, including operations 170a through 195, illustrates interactions that may not directly involve a consumer. Sides “A” and “B” are separated by a dashed line in FIG. 2. Of course, while FIG. 2 depicts an example method in accordance with the present disclosure, it will be appreciated that not all procedures depicted therein need be performed; alternatively, procedures not depicted therein may additionally be performed, while remaining within the scope of the present disclosure. Accordingly, FIG. 2 is provided as an example embodiment, while other embodiments with more or fewer procedures are possible.

With reference first to the blocks of side “A,” at block 110, a consumer may make a purchase or multiple purchases from a merchant that qualify the consumer for the rebate offered. Typically, the consumer may travel to a merchant to make a qualifying purchase. In other embodiments, it may not be necessary for the consumer to purchase the item or items at the merchant's physical location, and the consumer may purchase the item by other means, such as by mailing an order form or telephonically or electronically submitting an order, using, for example, a personal computer, PDA, or smartphone, or other such device having internet access. In a further embodiment, consumers may make a qualifying purchase in an electronic format, such as through designated sites connected to a global computer information network and accessible to the consumers through the global computerized information network. A global computer information network, such as the internet, may contain any number of websites that a user may access. Such websites may provide information for purchasing products and provide user interfaces through which users may transmit information about themselves, a product order, a credit card number, and the like.

Generally, a merchant may offer a rebate in situations where a consumer purchases a particular item, multiple items, or a combination of items, including items purchased in a single transaction or through multiple transactions, which may further occur on different dates. In other embodiments, a merchant may offer a rebate for any reason the merchant desires, such as a promotional rebate or a prize rebate. A merchant may include any product manufacturer or other business entity that provides goods or services to the public or other private or public entities.

Often, consumers do not learn of the rebate offer until after entering a merchant's physical or internet location. However, in some embodiments, a merchant may offer a rebate directly to consumers. In some embodiments, this may include notifying the consumer of the rebate offer. Typically, notification may be a written or oral communication indicating the terms of the rebate offer and instructing consumers with regard to satisfaction of the rebate offer. For example, consumers may be notified by a mass distributed flyer or advertisement. Such notifications may appear within printed or electronic media such as newspapers, magazines, journals and the like, internet publications or other internet websites, or any other advertising medium. Additionally, the notifications may be in the form of an email or delivered mail. Other forms of notification, such as oral communication or radio and television advertisements, are contemplated to be within the scope of the present disclosure.

Upon completion of a qualifying purchase, in some embodiments, a transaction may be recorded by a point-of-sale data processing and storage system. Typical point-of-sale data processing and storage systems may include a computerized system that receives purchase data either by manual entry by an operator or through scanning a Universal Product Code (“UPC”) supplied on the product packaging by either the merchant or the manufacturer. Often, the recording for each qualified purchase may include a transaction identifier or unique identification number (“UIN”). In one embodiment, the UIN may also be recorded on a receipt issued to the consumer, as shown at block 120. The receipt may be issued to the consumer directly, in the case of an in-store purchase, or electronically transferred to the consumer, in the case of an electronic purchase, wherein the consumer may use, for example, a personal computer, PDA, or smartphone, or other such device having internet access in order to access the receipt. An electronic receipt may be in the form of a transfer across a computer network, such as the internet. The point-of-sale data processing and storage system may be any system known in the art for recording and processing purchases at the point of sale.

In another embodiment, after making a qualifying purchase, consumers may be provided with a primary receipt and a secondary receipt. The secondary receipt may include a record of information associated with the qualifying purchase, including the UIN, whereas the primary receipt may include information associated with all purchases, including items not associated with rebate offers. The secondary receipt may also contain information with regard to how consumers may perfect satisfaction of the rebate offer. In another embodiment, the information contained on the primary receipt and secondary receipt, as described above, may include just a single receipt.

Subsequently, the consumer may submit a rebate claim to a rebate processing center, as shown at block 130. The consumer may submit a rebate claim to the rebate processing center by entering rebate information and consumer information into a kiosk or ATM located at the merchant location, at a shopping centering wherein the merchant is located, or at some other location. Alternatively or additionally, the consumer may enter rebate information and consumer information at home using the internet (e.g., by accessing a website indicated on the receipt(s)), for example, using a personal computer, PDA, or smartphone, or other such device having internet access. Rebate information to be entered by the consumer may include transaction information, including the UIN, as indicated on the receipt(s) received by the consumer, as discussed above. Consumer information may include any information that identifies or is associated with a particular consumer, which may include a consumer name, address, phone number, email address, or other personal information. Consumer information may also include of information regarding a particular consumer's more private information or lifestyle preferences and/or opinions, such as annual income, places where the consumer typically shops, items the consumer typically purchases, etc. Such information, if requested, may be useful in conducting consumer surveys and may, in one embodiment, be voluntarily offered by the consumer and not required to receive the rebate. Alternatively, in some embodiments, a rebate claim form may request only enough information to identify the consumer so that the rebate can be provided to the consumer. It is thus appreciated that the presently disclosed rebate system and method requires an affirmative action on the part of the consumer; that is, the consumer must approach the ATM or kiosk and provide necessary information thereto. This method and system therefore differs from existing rebate systems wherein the rebate is provided instantly, e.g., at the point of sale (automatically reducing the purchase price of the eligible product upon purchase).

In some embodiments, where, in addition to entering information into the kiosk or ATM, additional rebate information is required to be submitted directly to the processing center, or to another entity, the kiosk or ATM may provide the consumer with such information, including, for example, a destination address or a website address, a telephone number, rebate promotion information, and instructions for submitting material verifying the qualifying purchase, if necessary or desired. Such additional rebate information may be submitted by mail, by telephone, by electronic means such as the internet, which may include the use of PDAs or smartphones, or by any other means of information transmission.

For example, in one embodiment, a consumer may submit additional rebate information using a paper form by mailing the form to the rebate processing center, or other entity. In another embodiment, the additional rebate information may be submitted by telephone. The consumer may place a call to a predetermined telephone number. The predetermined telephone number may be connected to an interactive computerized telephone processing system, such as those used for voice-mail systems, consumer service telephone lines, etc. In some embodiments, data requested by the interactive computerized telephone processing system may be received in the form of tones generated by the numeric keys of a touch-tone telephone. In other embodiments, voice recognition may be used to receive the data in the form of a spoken response from the consumer. In yet another embodiment, consumers may be able to access an electronic form to submit the additional rebate information. For example, consumers may be directed to a web page identified by a uniform resource locator (“URL”) and accessible using a web browser connected to the internet. The consumer may access the URL in several manners. In one embodiment, the consumer may access the URL using a menu option at the merchant's or the rebate processing center's website. In some embodiments, the URL may appear to be the merchant's website, but in fact be the rebate processing center's website that is merely linked to the merchant's website. Additionally, the consumer may access the URL from any location. In one embodiment, the consumer may access the URL from a home computer system. In an alternative embodiment, the consumer may access the URL using a PDA or smartphone, or other known internet accessing means.

Upon entering the required rebate and consumer information into the kiosk or ATM, the kiosk or ATM can transmit such information (shown in FIG. 2 by line 131) via electronic communication network to the processing center for processing and validation of the rebate, as will be discussed in greater detail below.

Furthermore, upon entering the required rebate and consumer information into the kiosk or ATM, at block 140, the kiosk or ATM provides the consumer with a stored value rebate card that is “empty,” i.e., has no value stored thereon. Stored value rebate cards may include any debit or credit card, including Visa™, Mastercard™, Discover™, American Express™, or other credit card, loyalty card, smartcard, scannable device, or other card or device suitable for storing information relating to a stored value rebate card or rebate offer. In alternative embodiments, the rebate validation process may be instantaneous with the dispensing of the rebate card. For example, the ATM or kiosk may be configured to automatically validate a rebate claim based on the information provided by the consumer, and dispense a rebate card having a stored value thereon. Or, the communication between the ATM or kiosk and the rebate processing center may be such that the rebate claim is substantially instantly validated by the processing center upon receiving appropriate information from the ATM or kiosk, and a notification of validation may be substantially instantly communicated back to the ATM or kiosk for dispensing of a rebate card having a stored value thereon. Other configurations are also possible. For example, in other embodiments, the consumer may opt to receive the card at a later time, i.e., after the rebate claim has been validated and a value is added to the card, rather than receiving the card immediately upon using the kiosk or ATM.

In other embodiments, the consumer already has a stored value rebate card from a previously rebate claim. In this embodiment, the consumer need not reenter the consumer information, as the rebate card may be configured to identify the consumer as a previous or existing consumer by, for example, swiping the card through the card reader of the ATM or kiosk, or otherwise entering card-specific information into the kiosk. By avoiding repeated entries of personal information for each rebate claim, a consumer may save substantial time and effort over the traditional rebate process, wherein a separate rebate claim form needs to be filled out for each individual rebate claim.

Additional details regarding the ATM or kiosk, and the rebate card provided therefrom, will be discussed in greater detail below.

After the processing center validates the rebate claim submitted by the consumer, at block 150, the consumer may receive a rebate status notification from the rebate center. The rebate status notification may include information that the rebate claim has been approved, and that the value of the rebate has been added to the rebate card that the consumer previously received from the kiosk or ATM after entering the rebate and consumer information. Alternatively, the rebate status notification may include information that the rebate claim has been denied, wherein the notification may include steps that the consumer can take to remedy whatever defect in the rebate claim caused the claim to be denied. Alternatively or additionally, the consumer may be notified at the ATM or kiosk upon entering the rebate claim of a time at which to expect the rebate card to have a value added thereto. Such notification may include, for example, a description of the rebate, the rebate amount, the expiration date of the rebate value, or other information as may be desirable.

The consumer may be notified of the rebate claim status by any means, including, for example, telephone call, regular mail, e-mail, text message, or smartphone application. In another embodiment, the consumer may return to the ATM or kiosk at a later time to receive notifications regarding the rebate claim, including the status of the rebate claim (validation, denial, etc.). In one embodiment, the processing center has access to such notification means from the consumer information entered for the rebate claim.

In alternative embodiments, wherein the consumer either entered the rebate information from a location other than the kiosk or ATM (i.e., at home using a personal computer) or the consumer opted to receive the rebate card at a later time, the consumer, at block 151, may go to the kiosk or ATM to receive the stored value rebate card after receiving notification from the rebate processing center, for example, that the rebate claim has been validated and/or the rebate card account has a value added thereto.

After value has been added to the stored value rebate card, the consumer may use the stored value rebate card to purchase goods or services, as shown at block 160. In further embodiments, the stored value rebate card may be used at any merchant that accepts payment by credit, including the merchant that offered the rebate or other outside merchant. In some embodiments, the consumer may use the stored value rebate card a plurality of times until the value of the stored value rebate card has been substantially or completely used. For example, the consumer may make multiple transactions at multiple locations using the same stored value rebate card. The stored value rebate card may be, or may be similar to, a credit card, such that the stored value rebate card may be swiped in a credit card scanning device at the time of purchase and the stored value rebate card information may be automatically entered into the point-of-sale data processing and storage system. Alternatively, the stored value rebate card may contain a unique number, such as a credit card number, that an operator may manually enter into the point-of-sale data processing and storage system.

### Method of Processing a Rebate

With reference now to the blocks shown in side “B” of FIG. 2, in some embodiments, the merchant may send, via an electronic transmission network, reports from the point-of-sale data processing and storage systems including a plurality of purchase data records, e.g., information relating to the sales transactions for the merchant, to the processing center, as indicated by line 121. The processing center may receive such information at block 170a. In one embodiment, a purchase data record may include a list of the products purchased by a consumer, the date of the purchase transaction, and the UIN. The purchase data record may include a list of all the products purchased during the transaction and not merely the products associated with a rebate offer. Alternatively, to minimize the purchase data report file size, the purchase data records may be limited to include only the purchased items associated with a rebate offer. The purchase data record may also include other data such as the store number, the purchase price of each product purchased, etc. In one embodiment, the report may include only those purchase data records having information relating to sales transactions including items associated with rebate offers.

Furthermore, as discussed above with regard to block 130 and line 131, the processing center may receive information in the form of a report concerning one or more rebate claims that have been submitted by one or more consumers, as indicated at block 170b. Such reports may include the rebate and consumer information with respect to each rebate claim in the report, in addition to other claim information including when and where (i.e., at which kiosk or ATM) the rebate claim was made.

The rebate processing center may receive any such reports electronically, in the form of a transfer across the internet or a tangible electronic storage device containing the electronic file. The report may also be delivered via mail or courier service. Additionally, the rebate processing center may receive the reports of purchase data items on a periodic basis, such as daily, weekly, or other suitable periodic basis. In other embodiments, the rebate processing center may receive the reports at non-regular intervals, such as dates specified by the merchant or rebate processing center.

At block 180, after receipt of the rebate claim, in some embodiments, the rebate processing center may verify that the rebate claim corresponds to a valid qualifying purchase. Validating rebate claims may be done in any manner known in the art, and no particular method of validation is particular to the system and method of the present disclosure. In one embodiment, a rebate processing employee may manually validate the rebate claim. In a further embodiment, the rebate processing employee may validate the rebate claim by verifying the UINs provided by the consumer, verifying the items purchased qualify for a rebate offer, verifying the purchase was made during the qualifying time period, if any, and/or verifying other purchase details, such as number of items purchased, valid receipt information, etc., to be sure that the rebate claim meets initial criteria. In another embodiment, the rebate processing center may employ a computerized software that matches the UINs provided by the consumer on the rebate claim with the UINs provided to the rebate processing center in the purchase data records provided in the point-of-sale data processing and storage system reports, described above. The computerized software may further validate the rebate claim by verifying the items purchased qualify for a rebate offer, verifying the purchase was made during the qualifying time period, if any, and/or verifying other purchase details, such as number of items purchased, valid receipt information, etc. The computerized software may also automatically calculate the rebate total based on the purchase data records. For example, the computerized software, in one embodiment, may automatically determine which items, or combination of items, from a purchase data record are associated with a rebate offer or rebate offers, and determine the total rebate value owed to the consumer. In some embodiments, the total rebate value owed to a consumer may be determined from the items purchased across multiple sales transactions evidenced by multiple purchase data records.

Hardware and software components used by the rebate processing center may be integral portions of a single computer or server or may be connected to parts of a computer network. The hardware and software components may be located within the rebate processing center or may be operated offsite by a third-party subcontractor. In other embodiments, portions of the hardware and software components may be divided among a plurality of locations and connected directly or through a global computer information network, such as the internet.

Any combination of consumer identifying information, such as name, address, e-mail address, and the like and purchase identifying information, such as purchase location, purchase date, purchase item, and the like may further be used to validate the rebate claim in lieu of, or in addition to, the UIN. Alternatively, an operator may be employed to manually validate the rebate claims. Additionally, the rebate processing center may contact the merchant to verify that a qualifying purchase was made. The preceding examples of validation methods are meant only to provide examples of particular embodiments. The systems and methods of the present disclosure contemplate any form of validating a rebate claim. Similarly, the rebate processing center may bypass validation, or validation may be performed by another entity in lieu of the rebate processing center.

The rebate processing center may similarly check the rebate claims for fraud, for example, by comparing the name and address of the consumer to known databases containing consumer identities that may be suspicious or have previously been determined to act fraudulently. In other embodiments the fraud-checking step may be performed by an entity other than the rebate processing center or may be omitted entirely.

Once the rebate has been validated, the processing center may provide two notifications 190a and 190b. The notification 190a may be a notification to the consumer that the rebate claim has been validated and that the rebate card that the consumer received from the kiosk or ATM now has a value added to it. This notification block 190a occurs in the same manner as discussed above with regard to block 150 (consumer receives notification).

The notification 190b may be a notification to a rebate card account manager to add the validated rebate value to the consumer's rebate card. The rebate card account manager is the entity which manages the value on the rebate card, and is ultimately responsible for any purchases or redemption that the consumer makes using the rebate card. In one embodiment, the rebate card account manager may be a financial institution. Such financial institution may be responsible for maintaining the rebate card account, and providing payment to a merchant upon the consumer's use of the rebate card to purchase a product. In another embodiment, the rebate card account manager may be the rebate card issuer, for example, the merchant whereat the rebate card was received. The rebate card issuer may be associated with, or may be part of, a financial institution, in order to operate and maintain the rebate card accounts. Alternatively, it may be a stand-alone entity. In a further embodiment, the rebate card account manager may be the rebate processor. The rebate processor may be associated with, or may be part of, a financial institution, in order to operate and maintain the rebate card accounts. Alternatively, it may be a stand-alone entity. With regard to specific embodiments of the stored value rebate card, in the case of a debit or credit card, the rebate card account manager may be a financial institution. In the case of a loyalty card or smartcard, the rebate card account manager may be a rebate card issuer, such as a merchant.

The rebate card account manager may subsequently add value to the consumer's rebate card, upon receipt of notification or validation of the rebate. The notification 190b can be provided prior to or concurrently with the notification 190a to the consumer, such that the card is already “active” (i.e., has value) once the consumer receives the notification. The notification may be provided to the rebate card account manager by mail, e-mail, or other electronic form, as discussed above. In one embodiment, the information may be provided to the rebate card account manager on a periodic basis, such as daily, weekly, or other suitable periodic basis. In other embodiments, the information may be provided to the rebate card account manager at non-regular intervals, such as upon request by the rebate card account manager.

When a consumer uses the stored value rebate card to purchase goods or services, the rebate card account manager may fulfill payment obligations associated with consumer use of the stored value rebate card, as indicated at block 195. Such obligations may be similar to those obligations with respect to the use of a credit card. For example, the rebate card account manager may fulfill payment obligations to the sales merchant, the network supplying a connection between the rebate card account manager and the sales merchant or other intermediary parties involved in the transaction, and/or the processor of the transaction, etc.

### ATM or Kiosk

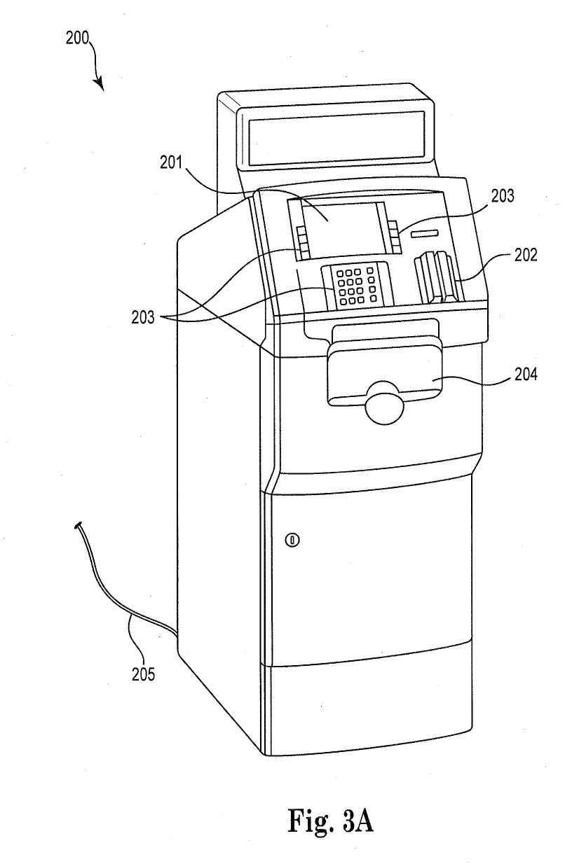

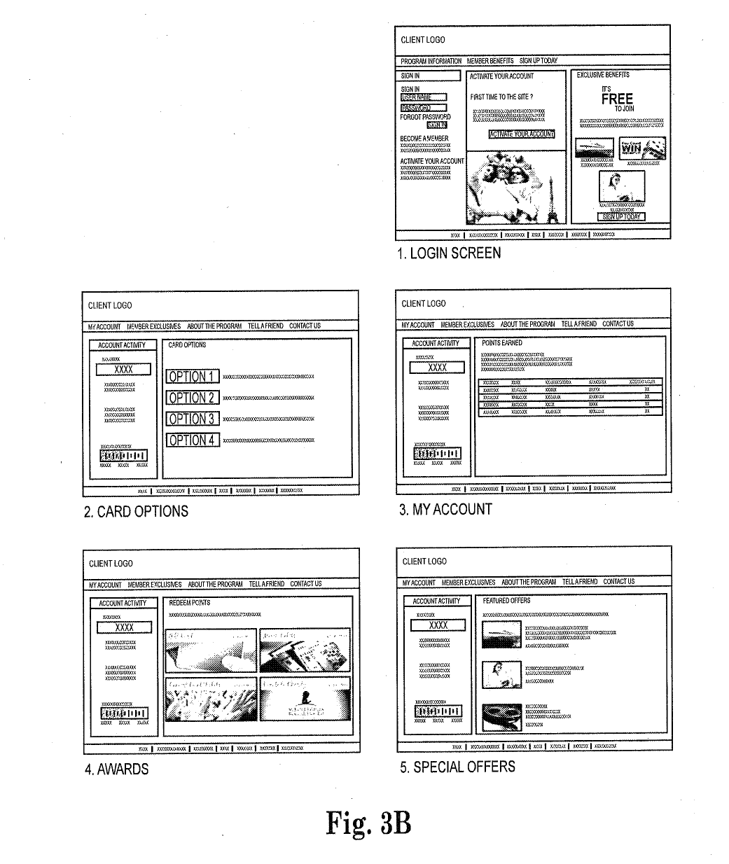

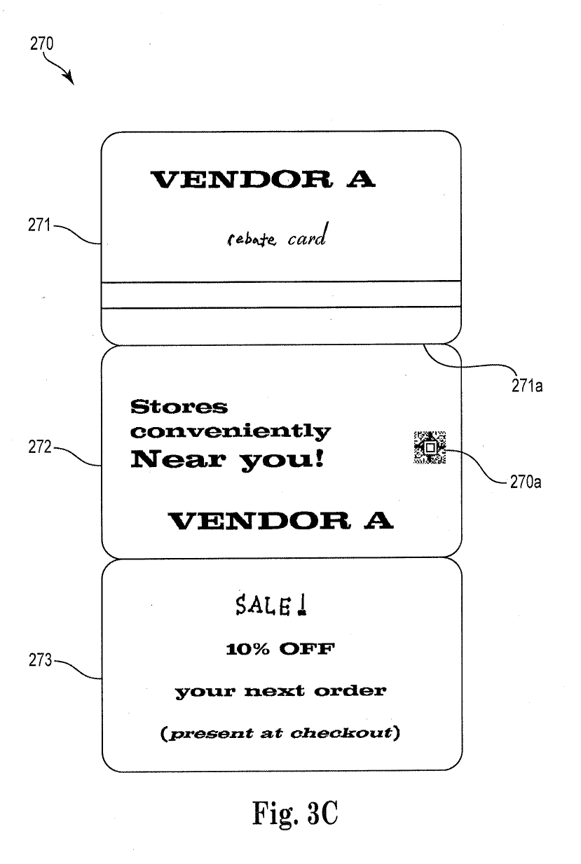

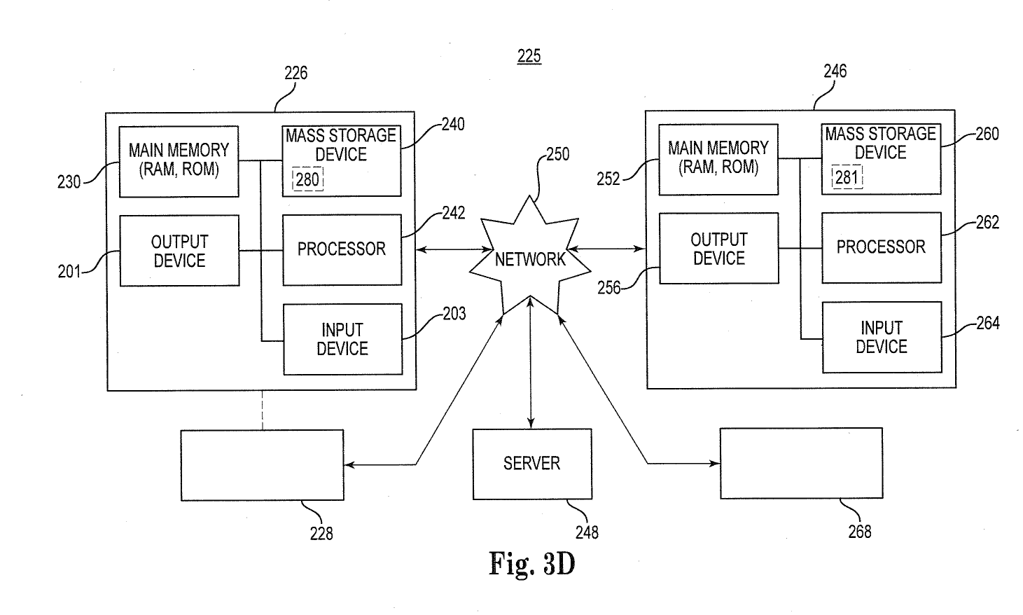

As discussed above, according to embodiments of the present disclosure, the consumer may submit a rebate claim by entering rebate information and consumer information into an ATM or kiosk, wherein the ATM or kiosk transmits such information via electronic network for processing and validation of the rebate claim. The kiosk or ATM may then provide the consumer with an empty stored value rebate card. FIG. 3a depicts a diagram of an example kiosk or ATM suitable for use with the systems and methods of the present disclosure.

The term ATM, in accordance with embodiments of the present disclosure, may generally be used to refer to machines including those capable of dispensing cash to a user, typically after the user inserts a card with electronically encoded information, such as name and account number. The value of the cash dispensed is deducted from one of the user's bank accounts and shows up on his bank statement. Currently, ATMs can be found in the lobbies of banks, in drive-through installations, in malls, in gas stations, in grocery stores, in airports, and in any place where a consumer may need to obtain cash.

According to embodiments of the present disclosure, ATMs may also be configured to dispense certain non-cash items, such as stored value rebate cards. These items are typically produced and presented through the same or a separate delivery slot than the cash which is presented to consumers. In other embodiments, non-ATM electronic machines, which may generally be referred to herein as kiosks, may be configured dispense items such as stored value cards.

As shown in FIG. 3a, an ATM or kiosk 200 may be provided having an output interface, which may be a screen 201, a card reader 202, one or more information input interfaces 203, a dispensing means, which may be a slot, 204, and an electronic transmission means, which may be a data cable 205 or other known transmission means. In use, according to embodiments of the present disclosure, a consumer will approach the ATM or kiosk, and read on-screen instruction that may be presented on the screen 201. The on-screen instructions may instruct the user to enter certain information, such as consumer information and rebate information, as discussed above, using the input interface 203. Once all required information has been entered, the ATM or kiosk 200 may transmit the information to the rebate processing center via transmission means 205, and thereafter dispense a stored value card to the consumer through the dispending means 204. The consumer may, in some embodiments, be required to swipe the card through the card reader 202. In this manner, card information regarding the dispensed card, such as a unique card identification number, can be transmitted as part of the rebate information to the rebate processor, to ensure that the proper card has value added thereto when the rebate claim is validated. Further, the ATM or kiosk may be able to associate the card information with the consumer's personal information, thereby linking the card account to the consumer. In some embodiments, a further message may be displayed on screen 201 to the consumer, indicating that the consumer should expect to receive notification when the rebate claim has been validated, and the value added to the rebate card. Additionally, if further steps are required to obtain the rebate, such message may instruct the consumers as to the further required steps.

An ATM or kiosk in accordance with the present disclosure, and as shown in FIG. 3d, may be part of a larger network system 225 of ATMs or kiosks. System 225 may include one or more ATMs or kiosks 226 connected with a network 250, such as the Internet. ATM or kiosk 226 can interact with a server 246 in order to input and receive information, for example but not limited to, rebate claim information and consumer information, as described above.

System 225 may also include the ability to access one or more web site servers 248 in order to obtain content from the Internet for use with the rebate card systems and methods described herein. While only one ATM or kiosk is shown for illustrative purposes, system 225 may include a plurality of ATMs or kiosks 226 and may be scalable to add or remove ATMs or kiosks to or from a network.

ATM or kiosk 226 illustrates components of an embodiment of a suitable ATM or kiosk for use with the present disclosure. ATM or kiosk 226 may include a main memory 230, one or more mass storage devices 240, a processor 242, one or more input devices 244, and one or more output devices 236. Main memory 230 may include random access memory (RAM), read-only memory (ROM), or similar types of memory. One or more programs or applications 280, such as a web browser, and/or other applications may be stored in one or more data storage devices 240. Programs or applications 280 may be loaded in part or in whole into main memory 230 or processor 242 during execution by processor 242. Mass storage device 240 may include, but is not limited to, a hard disk drive, floppy disk drive, CD-ROM drive, smart drive, flash drive, or other types of non-volatile data storage, a plurality of storage devices, or any combination of storage devices. Processor 242 may execute applications or programs to run systems or methods of the present disclosure, or portions thereof, stored as executable programs or program code in memory 230 or mass storage device 240, or received from the Internet or other network 250, for example, a network connecting the ATMs or kiosks with the rebate processing center. Input interface 203 may include any device for entering information into ATM or kiosk 226, such as but not limited to, a microphone, digital camera, video recorder or camcorder, keys, keyboard, mouse, cursor-control device, touch-tone telephone or touch-screen, a plurality of input devices, or any combination of input devices. Output device 201 may include any type of device for presenting information to a user, including but not limited to, a computer monitor or flat-screen display, a printer, and speakers or any device for providing information in audio form, such as a telephone, a plurality of output devices, or any combination of output devices.

Applications 280, such as a web browser, may be used to access information for rebate claim information transmission, for example, by connecting the host server of the rebate processing center. Any commercial or freeware web browser or other application capable of retrieving content from a network and displaying pages or screens may be used. In some embodiments, a customized application 280 may be used to access, display, and update information.

A server 246, for example located at a remote rebate processing center, may also be connected to the network 250. Server 246 may include a main memory 252, one or more mass storage devices 260, a processor 262, one or more input devices 264, and one or more output devices 256. Main memory 252 may include random access memory (RAM), read-only memory (ROM), or similar types of memory. One or more programs or applications 281, such as a web browser and/or other applications, may be stored in one or more mass storage devices 260. Programs or applications 281 may be loaded in part or in whole into main memory 252 or processor 262 during execution by processor 262. Mass storage device 260 may include, but is not limited to, a hard disk drive, floppy disk drive, CD-ROM drive, smart drive, flash drive or other types of non-volatile data storage, a plurality of storage devices, or any combination of storage devices. Processor 262 may execute applications or programs to run systems or methods of the present disclosure, or portions thereof, stored as executable programs or program code in memory 252 or mass storage device 260, or received from the Internet or other network 250. Input device 264 may include any device for entering information into server 246, such as but not limited to, a microphone, digital camera, video recorder or camcorder, keys, keyboard, mouse, cursor-control device, touch-tone telephone or touch-screen, a plurality of input devices, or any combination of input devices. Output device 256 may include any type of device for presenting information to a user, including but not limited to, a computer monitor or flat-screen display, a printer, or speakers or any device for providing information in audio form, such as a telephone, a plurality of output devices, or any combination of output devices.

Server 246 may store a database structure in mass storage device 260, for example, for storing rebate claim information, consumer information, and other data. Any type of data structure can be used, such as a relational database or an object-oriented database.

Processors 242, 262 may, alone or in combination, execute one or more applications 280, 281 in order to provide some or all of the functions, or portions thereof, of the rebate card system and method described herein.

FIG. 3b depicts an example series of screenshots (1 through 5) of the output device 201, or screen, of the kiosk or ATM 200 in accordance with one embodiment of the present disclosure, as may be seen by a consumer upon approaching or using the kiosk or ATM 200. As shown therein at screenshot 1, in one embodiment, the consumer may be invited to sign into an existing account, where the consumer already has a rebate card, or the consumer may be invited to activate an account, where the consumer has not yet received a rebate card. Furthermore, in order to entice the consumer to engage in the rebate process, the screed may advertise one or more benefits of engaging in the rebate process, for example, exclusive sweepstakes, instant win games, and exclusive coupons and discounts, among other benefits. In this manner, the consumer may use the ATM or kiosk not only to make a rebate claim, but to also engage in an ongoing customer relationship with the merchant (or other entity) by creating and maintaining an account in connection with the rebate claim or claims.

The user may select from among the options presented on the screen, as shown in FIG. 3b. Thereafter, the user may be presented with one or more screens relating to the option that the user has selected. For example, for a new consumer (i.e., one that does not already have a card) the ATM or kiosk may show a screen to allow the entry of both rebate and consumer information. Alternatively, for a returning consumer, the kiosk or ATM may ask the consumer to enter only the rebate information. Other screens are possible in accordance with the present disclosure, including ones relating a particular rewards program or a particular loyalty program of the merchant, as will be appreciated by those having ordinary skill in the art. Furthermore, screens may be displayed in any sequence, as desired.

Referring now to screenshot 2 of FIG. 3b, in one embodiment, the consumer may select from among a variety of options with regard to the rebate card and the consumer account associated with the rebate card. As shown therein, the consumer may opt to receive a rebate card, as discussed above, join a loyalty program as well as receive a rebate card, or make changes to an existing account associated with a rebate card by, for example, converting value on the card from loyalty points to cash, or even add cash to the card for future use, much in the way of a pre-paid card.

Referring now to screenshot 3 of FIG. 3b, in one embodiment, the user may access an existing account that may be, for example, associated with an existing rebate card the consumer has. In this manner, the user may be able to view the amount of value existing on the card (in cash, loyalty points, etc.) and view recent or past transactions that accrued value to the account (for example, rebate qualifying purchases), among other things.

Referring now to screenshots 4 and 5 of FIG. 3b, in one embodiment, the consumer may also be able to use the ATM or kiosk to redeem loyalty points for products or services, which may be promotional products or services associated with the merchant, or they may be other products and services associated with other merchants. Further, the consumer may be able to access other exclusive offers from the merchant or other merchants, for example, coupons, sweepstakes, surveys, or other exclusive offers.

It will thus be appreciated that the ATM or kiosk of the present disclosure may not only be provided to engage the consumer in the rebate process by allowing for the instant entry of a rebate claim and providing a rebate card in response thereto, but it may also be the access means for the consumer to continue the business relationship with the merchant or other entity by way of the consumer account that may be linked to the reusable rebate card. In this way, the consumer maintains an ongoing relationship with the merchant or other entity by having an account that can accrue cash and loyalty points, and provide offers of other products and services.

Of course, it will be appreciated by those having ordinary skill in the art that an ATM or kiosk is not the only means by which the consumer can access and stay engaged with the consumer's account in connection with the rebate card. Other means, such as a personal computer, PDA, or smartphone, or other such device having internet access may be used by the consumer to access the account. Information regarding account access may be provided to the consumer at the ATM or kiosk during the consumer's initial interaction therewith, or it may be provided by any other means of communication, including the receipt received from the merchant, email, telephone, or regular mail, etc.

### Stored Value Rebate Card

As discussed above, a stored value rebate card may be dispensed by the ATM or kiosk upon the entering of rebate information and consumer information by the consumer. The card may thereafter be swiped through the card reader of the ATM or kiosk, in order to associate the card information, such as a unique card identifier, with the rebate information and the consumer information. In this manner, a consumer may be effectively linked to a particular rebate card account, managed by a rebate card account manager (which may be a financial institution, a merchant, other account manager, or a combination of two or more thereof). Details of the configuration and operation of a stored value rebate card in accordance with one embodiment of the present disclosure are provided as follows.

In one embodiment, a stored value rebate card may used to access the value associated with the stored value account. The term value may generally be used herein as including a monetary amount in dollars or other currency, “points” or “credit” in a consumer loyalty program of a merchant, merchant association, or other association, or any other denomination of value which may be used to provide a rebate to a consumer. The stored value rebate card may have a unique identifier number that allows the stored value rebate card to be recognized by both the rebate card account manager and the rebate processor. The format of the identifier may depend on the embodiment of the stored value rebate card, which may be an access code, a digital certificate, a printed receipt, a ticket, a scannable card, microchip, radio frequency identification (“RFID”), or another type of media capable of storing the identifier number. The instrument identifier may be a number, a scannable symbol such as an Aztec Code or other barcode, or an electronic code such as that contained in a magnetic strip, microchip, or RFID. The instrument identifier may be a proxy number, which is typically used in credit card processing to protect the actual account number associated with a credit card. In one embodiment, the stored value rebate card is a credit-card-size scannable card, having a scannable symbol representing the identifier number, and a magnetic strip for swiping at an ATM or kiosk in accordance with the present disclosure.

The stored value rebate card may have a format that the stored value account manager or rebate processor may obtain to determine if the stored value rebate card is accepted by a certain merchant. Stored value rebate card formats include: a single-merchant card that uses a closed-format account and is only accepted at a particular merchant; a merchant-chain card that uses a closed-format account and is accepted at merchants that are partnered according to certain criteria, such as commonly-owned restaurants or subsidiaries of “big box” retailers; or an open-format card that uses an open-format account and may be accepted at any vendor that has agreed to accept it, such as a prepaid Visa™ or American Express™ card being accepted anywhere that such payment device can be used. The rebate card account manager or rebate processor may use the card identifier number for the stored value rebate card to obtain the format. The stored value rebate card may further be associated with unique incentives, such as product promotions or discounts on certain purchases, which may be obtained by the rebate card account manager or rebate processor in the same way that information regarding the format (open, closed, etc.) is obtained, as discussed above. The stored value rebate card may also have a preset expiration date, or the expiration date may be set upon purchase. Alternatively, it may have no expiration date.

The stored value rebate card may be issued by the rebate card account manager, the rebate processor, a specific vendor with which the stored value rebate card may be used, or another entity. In one embodiment, such entity may be responsible for supplying the ATMs or kiosks with rebate cards. In other embodiments, any other of the above entities may be so responsible. Alternatively, multiple entities may be responsible for both issuing the rebate cards and supplying the ATMs or kiosks with the rebate cards.

In some embodiments, the stored value rebate card must be “activated,” or swiped through the card reader of the ATM or kiosk, before it can be used to make purchases. In other embodiments, swiping is not necessary as the ATM or kiosk may employ means to track which card is dispensed to a consumer upon dispensing. In yet another embodiment, the consumer activates the stored value rebate card after receipt in a manner other than swiping the card, such as by calling an activation phone number or accessing the rebate card account manager's website and entering the card identifier, the rebate information, the consumer information, or any other information.

The stored value rebate card may be dispensed from the ATM or kiosk as part of a product bundle, such as a book or sheet including advertisements, coupons, additional rebate cards, or other incentives. The product bundle may have its own unique bundle identifier. Upon dispensing, in one embodiment, the bundle identifier may be collected by scanning an identifying portion of the bundle through the ATM or kiosk, which may include swiping an identifying portion of the product bundle through the card reader. In other embodiments, the ATM or kiosk has a priori knowledge (e.g., as supplied by the rebate card issuer, supplier) of the particular rebate card or bundle dispensed to the consumer, such that the consumer need not swipe the bundle through the card reader of the ATM or kiosk to identify it. Other means of identifying the bundle identifier are possible, such as online through a website or by telephone, as discussed above with regard to activation of the rebate card.

The rebate product sheet 270, shown in FIG. 3c and described below, is an example of a product bundle in accordance with the present disclosure. The product sheet 270 may have a length, width, and thickness that allow it to be loaded into a standard currency cassette in an ATM or kiosk. The product sheet 270 may have one or more substantially credit-card-sized separable portions, one or more of which contain a magnetic strip or other identifier, so that the separable portions may be used like a standard credit card on any standard point of sale device. Preferably, one of the substantially credit-card-sized separable portions is the stored value rebate card.

The stored value rebate cards may include single-merchant cards and/or merchant chain cards issued by merchants, and/or open-format cards issued by entities such as rebate card account managers. In the embodiment of FIG. 3c, the product sheet 270 may include a single-merchant card 271 having a card identifier number and an example value of $20, an advertising panel 272, and a coupon panel 273. The single-merchant card 271 may be separable from the advertising panel at a perforated edge 271a. The product sheet 270 may have a sheet identifier 270a. The product sheet 270 may have dimensions substantially similar to that of the national currency so that it can be easily dispensed from a standard ATM or kiosk cassette.

In some embodiments, the rebate card and/or bundle may be made from a plastic material, for example, polyester, which does not leave a track mark, of which any number of formulations may be appropriate, as known in the art. In one embodiment, the plastic material used may be recyclable, or it may be made out of an at least partially recycled material. The dimensions and tolerances of the card or bundle may be such that it is substantially compatible with the cash handling apparatus of an ATM, or like dispensing means of a kiosk. Specifically, the card may about 8 to 30 mils thick, in one embodiment, although other thicknesses are possible. For an ATM that is configured to handle United States currency, the rebate card may be about 65 to 95 millimeters, or about 2 inches, in width, although other widths are possible. The rebate card may be about 120 to 170 millimeters in length, although other lengths are possible. The rebate cards may be provided having tear, or shear, strengths in accordance with general industry practice, as will be appreciated by those persons who have ordinary skill in the art.

In one embodiment, the rebate card account manager may supply the rebate cards to the ATMs or kiosks, as necessary. In a further embodiment, the rebate card account manager may also print the rebate cards. That is, the rebate card account manager may imprint the necessary data, such as the unique card identifier number, on the rebate cards. In other embodiments, the rebate processing center, or any other suitable entity (including third-party providers), may be charged with these responsibilities.

In further embodiments, a rebate card in accordance with the present disclosure may be reusable. Particularly, the information storing components of the card may be configured to retain personal information of the consumer such that, each time the user is eligible for a rebate, the consumer need only swipe it through a card reader at the ATM or kiosk to provide the necessary personal information that would otherwise have to be entered manually. The ATM or kiosk may thus identify the existing rebate card holder, and process the rebate according to the consumer information previously entered. In this manner, the disclosed rebate claim system and method is even faster and more efficient than existing systems and methods.

### System for Providing a Rebate Card

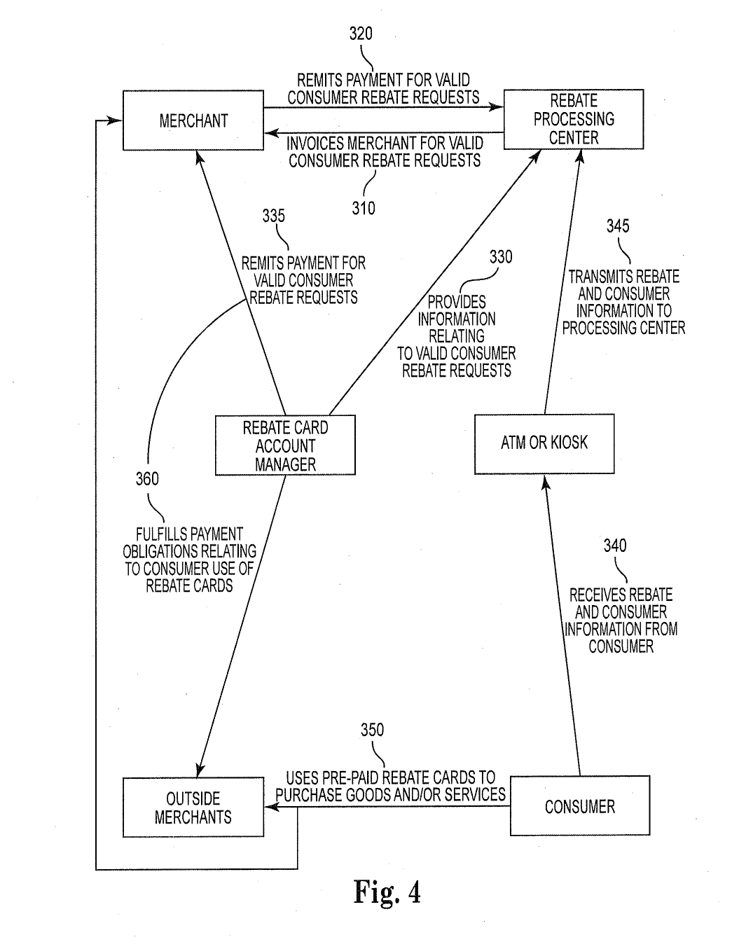

FIG. 4 illustrates example multi-party interactions 300 in a system for providing stored value rebate cards in accordance with one embodiment of the present disclosure. The interactions 300 may include, as their interacting parties, a merchant offering a rebate, one or more outside merchants, a kiosk or ATM that may be located at or near the merchant location, a rebate processing center, and a rebate card account manager.

Multiparty interactions 300 may begin with a consumer purchasing a product eligible for a rebate, and submitting a rebate claim. As shown at block 340, the ATM or kiosk receives rebate and consumer information from a consumer as part of a rebate claim entered at the ATM or kiosk, as discussed above. The kiosk or ATM, thereafter, may transmit such consumer and rebate information to the rebate processing center at block 345.

As shown in block 310, the rebate processing center may invoice the merchant for the value of the rebate claims submitted by consumers. In a further embodiment, the rebate processing center may invoice the merchant for the value of only the rebate claims that have been validated. As previously described, validating rebate claims may be done in any manner known in the art, and no particular method of validation is particular to the system and method of the present disclosure. Similarly, the rebate processing center may bypass validation, or validation may be performed by another entity in lieu of the rebate processing entity.

In addition to rebate claim validation, the rebate processing center may provide further services for the merchant, including but not limited to, providing the stored value rebate cards for supplying the ATMs or kiosks, rebate processing or other processing, customer service, and fulfillment of the stored value rebate cards (e.g., through the rebate card account manager). In some embodiments, the rebate processing center may be a direct contact point for the merchant and provide the consumers of the merchant with fulfillment services. In other embodiments, the rebate card account manager may issue and supply the rebate cards, as discussed above. In yet other embodiments, the services provided to the merchant by the rebate processing center may include customer service for the stored value rebate cards. For example, the rebate processing center may take customer service inquiries or telephone calls relating to problems during issuance of the stored value rebate cards, problems during activation of the stored value rebate cards, balance inquiries, etc. In other embodiments, the merchant or the rebate card account manager may handle customer service issues.

The merchant, in response to the invoices received from the rebate processing center, may remit payment to the rebate processing center for the consumer rebate claims, as illustrated at block 320. In one embodiment, the merchant may remit payment to the rebate processing center for only those rebate claims which have been validated by the rebate processing center.

At block 330, the rebate processing center may provide information relating to the consumer rebate claims to the rebate card account manager. Information may be provided to the rebate card account manager by mail, e-mail, or other electronic form, such as an electronic batch transfer, etc. In one embodiment, the information may be provided to the rebate card account manager on a periodic basis, such as daily, weekly, or other suitable periodic basis. In other embodiments, the information may be provided to the rebate card account manager at non-regular intervals, such as upon request by the rebate card account manager. In some embodiments, the information provided to the rebate card account manager relates to only those consumer rebate claims that have been validated by the rebate processing center.

At block 335, the rebate processing center may remit payment, which may be made for all rebate claims or for only validated rebate claims, to the rebate card account manager. In alternative embodiment, the merchant may remit payment directly to the rebate card account manager in response to an invoice sent therefrom, rather than using the rebate processing center as a payment intermediary as shown in FIG. 4. In this embodiment, the information transfer block 330 remains the same.

At block 350, the consumers may use the stored value rebate cards to purchase goods and/or services at any merchant, including the merchant where the rebate card was received or at another merchant, as was previously described and as is shown in. FIG. 4. For example, in some embodiments wherein the rebate card is a debit card, the consumers may use the stored value rebate cards at any merchant that accepts payment by the debit card issuer, which may be a rebate card account manager.

In addition to issuing the stored value rebate cards, the rebate card account manager may also fulfill payment obligations relating to consumer use of the stored value rebate cards, as shown at block 360. In some embodiments, the rebate card account manager may fulfill payment obligations similar to those obligations with respect to the use of a credit card. For example, the rebate card account manager may fulfill payment obligations to the merchant, the network supplying a connection between the rebate card account manager and the merchant, or other intermediary parties involved in the transaction, and/or the processor of the transaction, etc.

U.S. patent application Ser. No. 11/748,201, published as United States patent application publication no. 2008/0288340, describes a three-party agreement between a merchant, the rebate processing center, and a financial institution for providing pre-paid rebate cards. Such agreements may be used in connection with embodiments of the present disclosure. As such, the contents of United States patent application publication no. 2008/0288340 are incorporate by reference herein in their entirety.

### Benefits of the Systems and Methods Disclosed

A stored value rebate card may offer several benefits to the consumer. A stored value rebate card may be easier to use than a rebate check. Additionally, a stored value rebate card of the present disclosure may allow the consumer to use the rebate card at generally any location that accepts payment by credit rather than only the initial merchant that offered the rebate. Furthermore, an un-banked consumer can avoid the hassle associated with cashing a rebate check at a rebate card account manager, where, for instance, they might be charged a fee.

The present disclosure may similarly provide several benefits to the parties involved, e.g., the merchant, the rebate processing center, and the rebate card account manager. For example, the merchant may provide a more desirable rebate than that of traditional rebate offers without further cost to the merchant. The rebate processing center can avoid handling monetary transfers directly to the consumer upon rebate redemption and can further avoid handling monetary transfers to outside merchants, where the consumer has used the stored value rebate card. The term “outside merchant,” as used herein, may include those merchants or other entities that provide goods and/or services that are not the same merchant as the merchant that offered the initial rebate to the consumer. The rebate card account manager may benefit since it becomes a participant in consumer rebate programs. For example, the rebate card account manager may receive income from slippage in consumer use of the stored value rebate cards.

Embodiments of the present disclosure may further provide benefits with regard to the immediacy with which the consumer is engaged directly in the rebate process. In existing systems, the consumer must wait weeks or even months before receiving a rebate after submitting a rebate claim. Thus, there is a disincentive for a consumer to participate in such a program. In embodiments of the present disclosure, the consumer is provided with a rebate card very soon after making the rebate qualifying purchase. Even though the rebate card may, in some embodiments, be “empty” until the rebate has been processed in the traditional manner, the consumer becomes engaged in the process, as the consumer now at least is keeping the rebate card received from the ATM machine or kiosk, in addition to the other coupons or offers presented to the consumer where a bundled product is dispensed. Thus, consumer behavior may be substantially changed in that the rebate process becomes a much more active, consumer-centric process as opposed to existing mail-in or online only rebate systems.

Embodiments of the present disclosure may further provide benefits with regard to the ability to track consumer behavior after receiving a rebate. In existing systems wherein a rebate check is mailed to the consumer, which may be cashed or deposited into a bank account, there is no means available to track when or where the consumer spends the rebate. For example, there is no means to determine if the consumer spends that rebate at the merchant location where the consumer received the rebate, or at another related or unrelated location. In contrast, the rebate card system and method disclosed herein may allow the rebate card account manager to track the activity of the consumer once the rebate card is used. In this manner, the account manager can gain valuable information about the consumption behavior of the consumer which may be used to provide additional valuable offers to the consumer (mindful, of course, that the account manager has access to the consumer's personal information as submitted during the rebate claim process). Such “data mining” techniques are well known and appreciated by those having ordinary skill in the art. Such information may further be helpful in designing better marketing and rebate programs for consumers. Through the collection of this type of data, merchants may identify specific individual consumers for targeted rebate offers, analyze general demographic trends among large groups of consumers, determine whether the stored value rebate cards are being used, determine where the stored value rebate cards are being used most, etc.

Embodiments of the present disclosure may further provide benefits with regard to the security of the rebate process, especially as applied to the rebate paying merchant. It is well understood that fraud is a problem with regard to the processing and validation of rebates. For example, a consumer could purchase a product, submit a rebate claim using the rebate receipt obtained at purchase, and then simply return the product for a refund. Often, the rebate processor has no immediate way to determine whether a product has been returned, and thus a rebate may be erroneously validated and issued, with no way to “recall” or “cancel” the rebate. In embodiments of the present disclosure, the rebate card account manager has control over the value in the stored value rebate card and can deduct any value therefrom at any time if it is subsequently determined that the consumer is no longer entitled to the rebate. In this manner, the merchant may be protected from paying invalid rebate claims.

Embodiments of the present disclosure may further provide benefits with regard environmental considerations. Existing paper-based rebate systems use a significant amount of paper for the rebate claim form, the rebate document, and the mailing materials required to send/receive the same. This paper is replicated for each rebate claimed. The presently disclosed rebate card, in contrast, may employ a reusable plastic card, which may, in some embodiments, be made of a recyclable material. Thus, waste paper is eliminated, and the consumer can potentially keep reusing the same card for each rebate received.

Embodiments of the present disclosure may further provide benefits with regard to the synergies achieved between the rebate processor and the rebate card account manager. By linking both entities to the same information received from the same ATM or kiosk transaction, substantial savings may be realized in terms of the communication and data transfer that would otherwise be required between these entities to process a rebate claim and to thereafter add value to the rebate card.

Certain aspects of the embodiments described in the present disclosure may be provided as a computer program product, or software, that may include, for example, a computer-readable storage medium or a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular embodiments. Functionality may be separated or combined in procedures differently in various embodiments of the disclosure or described with different terminology. These and other variations, modifications, additions, and improvements may fall within the scope of the disclosure as defined in the claims that follow.

What is claimed is:

1. A method for providing a rebate card to a consumer using an electronic kiosk, comprising:
receiving, into the kiosk, consumer information and rebate information;
transmitting, from the kiosk, the consumer information and the rebate information, via an electronic network, to a rebate processor; and
dispensing, from the kiosk, the rebate card to the consumer,
wherein, upon receiving the consumer information and the rebate information, the rebate processor validates the information and directs a rebate card account manager to add a value to the rebate card.

2. The method of claim 1, wherein the kiosk is an ATM.

3. The method of claim 1, wherein the rebate card is dispensed as part of a product bundle.

4. The method of claim 1, wherein rebate information comprises information regarding the purchase of a rebate qualifying product.

5. The method of claim 4, wherein the kiosk is located at a merchant located whereat the qualifying product was purchased.

6. The method of claim 4, wherein the rebate card is usable only at a location whereat the qualifying product was purchased.

7. The method of claim 1, wherein the rebate card is reusable.

8. A system for providing a rebate card to a consumer, comprising:
an electronic kiosk, the kiosk including:
an electronic data input means;
an electronic data transmission means; and
a rebate card dispensing means; and
a rebate card configured to be stored within and dispensed from the kiosk,
wherein the kiosk is configured to receive rebate information and consumer information from a consumer through the data input means, transmit the rebate and consumer information to a rebate processor via the data transmission means, and dispense a rebate card to the consumer via the rebate card dispensing means.

9. The system of claim 8, wherein the kiosk is an ATM.

10. The system of claim 9, wherein the rebate card forms part of a product bundle configured to be dispensed through the dispensing means of the ATM.

11. The system of claim 8, wherein the rebate card includes a card identifier number.

12. The system of claim 8, wherein the kiosk further includes a card reader means.

13. The system of claim 8, wherein the kiosk further includes a display means.

14. The system of claim 8, where the kiosk is connected via an electronic network connection to the rebate processor.

15. A method for processing a rebate claim using a computer-implemented processing system, comprising:
receiving, into the processing system, rebate information and consumer information, via an electronic network, from a kiosk configured to provide a rebate card to the consumer;
validating in the processing system, using electronically implemented validating procedures, the rebate information and the consumer information;
electronically notifying a rebate account manager to add a value to the rebate card; and
electronically notifying the consumer that the rebate card has a value added.

16. The method of claim 15, further comprising receiving validating information from a merchant regarding a consumer purchase of a rebate eligible product.

17. The method of claim 16, wherein the processing system invoices a merchant the merchant upon validation of the information.

18. The method of claim 15, wherein the consumer is notified by email.

19. The method of claim 15, wherein notifying the consumer and notifying the rebate account manager occurs after validating the rebate information.

20. The method of claim 15, wherein the account manager is a financial institution and the rebate card is a debit card of the financial institution.
